(19) United States
(12) Patent Application Publication
(10) Pub. No.: US 2020/0211007 A1
(43) Pub. Date: Jul. 2, 2020

(54) BLOCKCHAIN-BASED PRODUCT PURCHASE METHOD AND APPARATUS

(71) Applicant: ALIBABA GROUP HOLDING LIMITED, Grand Cayman (KY)

(72) Inventor: Min LI, HANGZHOU (CN)

(21) Appl. No.: 16/722,772

(22) Filed: Dec. 20, 2019

(30) Foreign Application Priority Data
Dec. 29, 2018 (CN) 201811641034.3

(51) Int. Cl. G06Q 20/38; G06Q 30/02; H04L 9/06; G06Q 20/36

(52) U.S. Cl. CPC G06Q 20/38215; G06Q 20/3829; G06Q 20/3674; H04L 9/0637; G06Q 30/0234

(57) ABSTRACT

One or more embodiments of this specification provide a computer-implemented method and apparatus for blockchain-based transactions. The method includes: receiving a target purchase transaction which comprises identification information of a purchaser user of a target product and a payment asset proof of the purchaser user; and invoking, based on the target purchase transaction, a first smart contract deployed on a blockchain to execute a purchase of the target product, and to distribute, to the purchaser user, the target product in a quantity corresponding to the payment asset proof.

### CROSS REFERENCE TO RELATED APPLICATION

The present application is based on and claims priority to Chinese Patent Application No. 201811641034.3, filed on Dec. 29, 2018, which is incorporated herein by reference in its entirety.

### TECHNICAL FIELD

The application relates to the field of data processing technologies, and in particular, to a method and apparatus for blockchain-based transactions.

### BACKGROUND

Blockchain, also known as a distributed ledger technology, is an emerging technology in which multiple computing devices participate in “accounting” to maintain a complete distributed database jointly. The blockchain technology is decentralized and transparent, each computing device can participate in maintaining records in the database, and data can be quickly synchronized among the computing devices. With the aforementioned characteristics, the blockchain technology has been widely applied in many fields.

### SUMMARY

The specification provides a computer-implemented method for blockchain-based transactions. The method may comprise: receiving a target purchase transaction which comprises identification information of a purchaser user of a target product and a payment asset proof of the purchaser user; and invoking, based on the target purchase transaction, a first smart contract deployed on a blockchain to execute a purchase of the target product, and to distribute, to the purchaser user, the target product in a quantity corresponding to the payment asset proof.

In some embodiments, invoking, based on the target purchase transaction, a first smart contract deployed on a blockchain to execute a purchase of the target product, and to distribute, to the purchaser user, the target product in a quantity corresponding to the payment asset proof comprises: generating a purchase proof for the purchaser user, for the purchase proof to be recorded in a distributed database of the blockchain in response to the purchase proof being verified by a plurality of nodes of the blockchain based on a consensus, wherein the purchase proof comprises the identification information of the purchaser user and the quantity of the target product corresponding to the payment asset proof.

In some embodiments, the quantity of the target product is a proportion of an ownership of the target product. In some embodiments, the target purchase transaction is an account transfer transaction sent by a node associated with the purchaser user for transferring a smart asset in the blockchain. In some embodiments, the identification information of the purchaser user includes a public key of the purchaser user or an address of a blockchain account of the purchaser user in the blockchain. In some embodiments, the payment asset proof includes a payment proof of token, digital asset, cash, security, coupon, or real estate, or a bank account transfer proof. In some embodiments, the target purchase transaction is sent by a node associated with a seller user of the target product; and the target purchase transaction includes payment receipt information.

In some embodiments, the method further comprises: receiving a target income transaction sent by a node associated with an operator of the target product, wherein the target income transaction comprises a total income obtained by operating the target product by the operator; and invoking, based on the target income transaction, a second smart contract to distribute an income to the purchaser user based on the quantity of the target product distributed to the purchaser user.

In some embodiments, the method further comprises: receiving a purchase transfer transaction sent by a node associated with the purchaser user, wherein the purchase transfer transaction comprises identification information of a transferee user, and a transfer quantity of the target product or a payment asset proof corresponding to the transfer quantity of the target product; and invoking, based on the purchase transfer transaction, the first smart contract to distribute the transfer quantity of the target product to the transferee user.

In some embodiments, the blockchain is a consortium blockchain. In some embodiments, the purchaser user is a user who has passed a real-name authentication.

In some embodiments, the consensus is based on a Proof of Work (PoW) mechanism, a Delegated Proof of Stake (DPoS) mechanism, a Proof of Stake (PoS) mechanism, a Practical Byzantine Fault Tolerance (PBFT) consensus algorithm, or a RAFT consensus algorithm.

The specification further provides an apparatus for blockchain-based transactions. The apparatus may comprise one or more processors and one or more non-transitory computer-readable memories coupled to the one or more processors and configured with instructions executable by the one or more processors to cause the apparatus to perform operations comprising: receiving a target purchase transaction which comprises identification information of a purchaser user of a target product and a payment asset proof of the purchaser user; and invoking, based on the target purchase transaction, a first smart contract deployed on a blockchain to execute a purchase of the target product, and to distribute, to the purchaser user, the target product in a quantity corresponding to the payment asset proof.

The specification further provides a non-transitory computer-readable storage medium configured with instructions executable by one or more processors to cause the one or more processors to perform operations comprising: receiving a target purchase transaction which comprises identification information of a purchaser user of a target product and a payment asset proof of the purchaser user; and invoking, based on the target purchase transaction, a first smart contract deployed on a blockchain to execute a purchase of the target product, and to distribute, to the purchaser user, the target product in a quantity corresponding to the payment asset proof.

According to foregoing embodiments of the blockchain-based product purchase method and apparatus provided in this specification, a first smart contract is invoked by using a blockchain transaction, to perform an operation of purchasing a target product. Because the purchase operation is performed after consensus verification by the blockchain nodes, the purchase operation is fairly performed, and the result of the operation is prevented from being tampered with.

### BRIEF DESCRIPTION OF THE DRAWINGS

FIG. 1 is a flowchart of a method for blockchain-based transactions according to some embodiments of this specification;

FIG. 2 is a schematic diagram of an apparatus for blockchain-based transactions according to some embodiments of this specification; and

FIG. 3 is a structural diagram of hardware implementing an apparatus for blockchain-based transactions according to some embodiments of this specification.

### DETAILED DESCRIPTION OF THE APPLICATION

Embodiments of the specification will be described in detail, examples of which are illustrated in the accompanying drawings. In the following description involving the accompanying drawings, the same numbers in different drawings represent the same or similar elements unless otherwise indicated. The implementations set forth in the following description of embodiments do not represent all implementations consistent with the one or more embodiments of this specification. Instead, they are merely examples of apparatuses and methods consistent with some aspects related to the one or more embodiments of this specification as recited in the appended claims.

In other embodiments, steps of methods are not necessarily performed according to the sequence shown and described in this specification. In some other embodiments, the methods may include more or fewer steps than those described in this specification. In addition, a single step described in this specification may be split into multiple steps for description in other embodiments. Multiple steps described in this specification may be combined into a single step for description in still other embodiments.

When purchasing a product, a purchaser usually signs a contract with a seller of the product to ensure the validity or legality of the purchase behavior. The purchaser and the seller carry out payment and product ownership transfer procedures according to the agreement in the contract. When the product is a large unportable product, or the product is far away from the purchaser and it is inconvenient to hand over the ownership of the product on site, how to ensure that the purchaser and the seller conveniently carry out the product purchase or sale according to the agreement in the contract becomes a common problem.

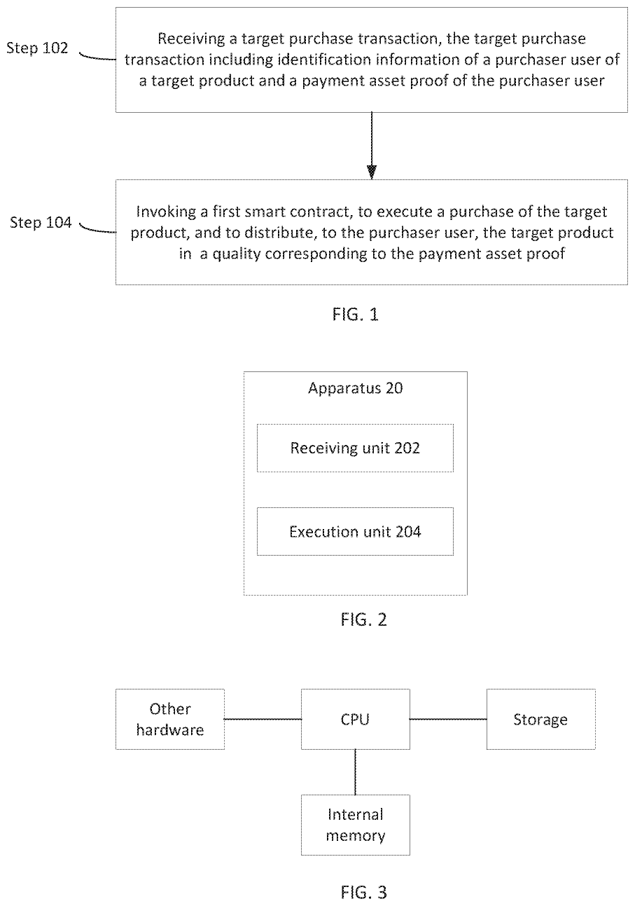

FIG. 1 is a flowchart of a method for blockchain-based transactions according to some embodiments of this specification.

A blockchain described in the embodiments may refer to a computer network system of blockchain nodes based on a consensus mechanism and a distributed data storage structure. The data in the blockchain is stored in multiple temporally connected “blocks,” with one block containing a data digest of the preceding block in a chain. The consensus mechanism may comprise, for example, Proof of Work (PoW), Proof of Stake (PoS), Delegated Proof of Stake (DPOS), or Practical Byzantine Fault Tolerance (PBFT). Since blockchain systems operate under a corresponding consensus mechanism, the data recorded in the blockchain's database cannot be easily tampered with by individual blockchain nodes. Therefore, unlike centralized database systems, the blockchain system has incomparable features of ensuring data security and preventing attacks and tampering. In the embodiments provided in this specification, data recorded in the distributed database of the blockchain cannot be attacked or tampered with, thereby ensuring the authenticity and accuracy of code data corresponding to purchase management logic declared in the first smart contract for managing purchase and/or sale of the target product.

A first smart contract for purchase management of a target product is deployed on a blockchain. In some embodiments, the first smart contract may be compiled computer executable programs deployed on the blockchain. Before being deployed on the blockchain, the first smart contract is verified by nodes of the blockchain based on a consensus. In some embodiments, the first smart contract, including purchase logic for the target product, can be recorded into a distributed database of the blockchain in response to the first smart contract being verified by the nodes of the blockchain based on the consensus. In addition, an execution result of executing the purchase logic (if any) after each node invokes the first smart contract is also recorded in the distributed database of the blockchain in response to the execution result being verified by the nodes of the blockchain based on a consensus.

Each node of a blockchain may join the blockchain by following a corresponding node protocol and installing a node protocol program, so as to serve as a node of the blockchain. In some embodiments, a node having a full data backup of the distributed database of the blockchain may be referred to as a full node, and a node having a partial data backup of the distributed database of the blockchain (for example, a backup of data of blocks' headers) as a light node, a client, or the like. The node in the embodiments may include a full node, or a light node or client. Any device that is directly or indirectly connected into the blockchain and can send data to or obtain data from the distributed database of the blockchain can be referred to as a blockchain node (or a node) of the blockchain.

In addition, the first smart contract for the purchase of the target product may be deployed by different deployers in different embodiments. For example, the first smart contract may be submitted by a node associated with a seller user (also referred to a seller) of the target product, verified by the nodes of the blockchain based on a consensus, and then deployed on the blockchain. In another example, the first smart contract may be submitted by a dedicated first smart contract deployment user, verified by the nodes of the blockchain based on a consensus, and then deployed on the blockchain. In other examples, the first smart contract for the purchase of the target product may be deployed by other entities.

In a conventional way, when a user purchases a large unportable product, a remote product, or a virtual product, the user usually signs a purchase contract with a seller of the product, and completes the purchase of the product based on a product price and a payment method rule stipulated in the purchase contract. Therefore, the first smart contract in one or more embodiments of this specification can be composed, and then wait for consensus verification by nodes associated with the seller and the purchaser on the blockchain, so as to be recorded in the distributed database of the blockchain. Alternatively, the first smart contract may be generated based on the product purchase contract. For example, codes corresponding to product purchase logic declared in the first smart contract may be composed based on the product price and the payment method rule stipulated in the product purchase contract. In another example, a product price and a payment method rule agreed upon by the seller and the purchaser may be imported into a product purchase contract template, and the first smart contract is generated based on the contract template. Other methods for generating the first smart contract may be used. After being generated, the first smart contract can be compiled and deployed onto the blockchain, thereby avoiding a complex procedure and expenses for signing a paper contract by the seller and the purchaser.

As shown in FIG. 1, the blockchain-based product purchase method includes the following steps 102-104.

Step 102: Receiving a target purchase transaction, the target purchase transaction including identification information of a purchaser user of a target product and a payment asset proof of the purchaser user.

The transaction described in this specification refers to a piece of data that is created by a user through a node of a blockchain and to be submitted to a distributed database of the blockchain. Transactions in the blockchain may be classified into transactions in a narrow sense and transactions in a broad sense. In a narrow sense, a transaction refers to a value transfer submitted by a user to the blockchain. For example, in a Bitcoin blockchain network, a transaction may be a Bitcoin transfer initiated by a user in the Bitcoin blockchain network. In a broad sense, a transaction refers to a piece of data related to a transaction submitted by a user to the blockchain. The piece of data related to a transaction may be relevant to a value transfer, or may be irrelevant to a value transfer. In some embodiments, the target purchase transaction is a piece of data that includes the identification information of the purchaser user of the target product and the payment asset proof of the purchaser user. The target purchase transaction is used for invoking the first smart contract. To ensure that the first smart contract is invoked smoothly, the target purchase transaction satisfies the content and format requirements of a target purchase transaction that can be accepted by the first smart contract.

The target product can be of any type. For example, any physical or virtual object whose full or partial ownership, right to income, or other rights can be sold or transferred may be incorporated into the scope of the target product. In some embodiments, the identification information of the purchaser user of the target product is identifier information for identifying an identity of a purchaser, for example, a public key of a blockchain account of the purchaser, an address of the blockchain account, or other anonymous information. In some embodiments, in accordance with national regulatory requirements on special products, the identification information of the purchaser of the special products may further include real-name information of the purchaser, for example, an ID card, business license information, etc. The content and format of the identification information of the purchaser may be determined according to the content and format requirements of the target purchase transaction stipulated in the first smart contract.

In some embodiments, the payment asset proof of the purchaser user may include a payment proof of smart assets in the blockchain, such as tokens or other digital assets, or may include a payment proof of off-chain assets such as cash, security, coupon, and real estate out of the blockchain.

The target purchase transaction may be sent to the blockchain by different entities in different embodiments. For example, according to different types of payment asset proofs, to ensure the legality and validity of the payment asset proofs, the identity of the sending user of the target purchase transaction may be different.

For example, when the purchaser user of the target product pays for the purchase of the target product through a token transfer in the blockchain, the target purchase transaction may be an account transfer transaction sent by a node associated with the purchaser user (also referred to as a purchaser node) of the target product to the first smart contract for transferring tokens to pay for the purchase of the target product and/or for transferring a quantity of the target product. An account transfer transaction between blockchain accounts (including an account of the first smart contract) may include identification information, such as a public key or an address of the account, of a transferor (e.g., the purchaser), and transaction amount information of the transfer.

In another example, when the purchaser user of the target product pays for the purchase of the target product through an off-chain asset transfer (such as a currency transfer between bank accounts), the target purchase transaction may be sent by the purchaser node of the target product and may include a bank account transfer proof. Alternatively, to further ensure the authenticity of the transfer payment, the target purchase transaction may be sent by a node associated with a seller (also referred to as a seller node) of the target product and may include payment receipt information.

In some embodiments, to invoke the first smart contract to execute corresponding execution logic (e.g., a course of actions or a set of rules), the target purchase transaction for invoking the first smart contract may further include invoking information of the first smart contract, for example, an address of the first smart contract, a name or an interface of a corresponding execution function, etc.

Step 104: Invoking a first smart contract, to execute a purchase of the target product, and to distribute, to the purchaser user, the target product in a quantity corresponding to the payment asset proof.

In some embodiments, a first smart contract may be invoked to execute purchase logic in the first smart contract for a purchase of the target product, and to distribute, to the purchaser user, the target product in a quantity corresponding to the payment asset proof. In some embodiments, invoking the first smart contract to execute a purchase of the target product, and to distribute, to the purchaser user, the target product in a quantity corresponding to the payment asset proof may be implemented in many ways. For example, the target product may be distributed to the purchaser user in the quantity corresponding to the payment asset proof or in coordination with other smart contracts (e.g., when the target product is smart assets in circulation on the blockchain). In another example, a purchase proof may be generated for the purchaser user, so that the purchase proof is recorded in a distributed database of the blockchain after being verified by the nodes of the blockchain based on a consensus, where the purchase proof includes the identification information of the purchaser user and the quantity of the target product corresponding to the payment asset proof.

When a node of the blockchain receives the target purchase transaction during a broadcasting process of the target purchase transaction, the node of the blockchain may invoke the first smart contract pointed to by the target purchase transaction (for example, the first smart contract is invoked based on the address and the function interface of the first smart contract that are included in the target purchase transaction), so as to execute the purchase logic declared in the first smart contract for the purchase of the target product and generate an invoking and execution result, that is, the purchase proof for the quantity of the target product. After the result of invoking and executing the first smart contract by the node of the blockchain (that is, the purchase proof) is verified by the blockchain nodes based on a consensus, the invoking and execution result can be recorded into the distributed database of the blockchain for recordkeeping. Because the purchase proof includes information such as the identification information of the purchaser user and the quantity of the target product corresponding to the payment asset proof, based on a tamper resistance mechanism of the blockchain, the content of the purchase proof will not be tampered with maliciously, thereby effectively ensuring the authenticity and validity of the purchase behavior of the purchaser user.

In some embodiments, the quantity of the target product may be a proportion of an ownership of the target product obtained based on the assets paid by the purchaser. For example, when the target product is a large or expensive product, multiple purchaser users may purchase the product in partnership, and each user is entitled to the right or profit of the product according to a ratio of investments of the users. In some embodiments, the quantity of the target product may be the number of the target products obtained based on the assets paid by the purchaser. For example, when the target products are virtual products such as small-amount products, funds, or stocks, the purchaser user may obtain a corresponding number of the target products based on the assets paid by the purchaser user.

In some embodiments, a detailed process of recording the purchase proof into the distributed database of the blockchain may be set according to the consensus mechanism and transaction rules of the blockchain. In some embodiments, the process of recording the purchase proof into the distributed database of the blockchain includes the following steps. Nodes having a bookkeeping authority in the blockchain add an execution result, e.g., the purchase proof, to a candidate block after invoking and executing the first smart contract. A consensus bookkeeping node satisfying the consensus mechanism of the blockchain is determined from the nodes having the bookkeeping authority. The consensus bookkeeping node broadcasts the candidate block to other nodes of the blockchain. After the candidate block passes verification of a preset quantity of nodes of the blockchain, the candidate block is added to the distributed database of the blockchain as a new block.

In the foregoing embodiments, the nodes having a bookkeeping authority may refer to nodes having an authority of generating candidate blocks. According to the consensus mechanism of the blockchain, a consensus bookkeeping node may be determined from the nodes having the authority of generating the candidate blocks. The consensus mechanism may include a Proof of Work (PoW) mechanism, a Proof of Stake (PoS) mechanism, a Delegated Proof of Stake (DPoS) mechanism, or the like.

Similar to the PoW mechanism, the PoS and DPoS consensus mechanisms are both consensus algorithms commonly used for determining a consensus bookkeeping node in a public blockchain. In some embodiments, in order to reduce the time spent on confirming a transaction or data, improve transaction throughput, and meet requirements on security and performance, the blockchain may be constructed by using a consortium blockchain architecture. The foregoing purchaser node, the seller node, a regulatory institution for regulating purchase behaviors of related target products, a judicial institution, or the like, may be used as a preselected consortium member node of the consortium blockchain to participate in bookkeeping of the blockchain. The consensus process of the consortium blockchain is controlled by the preselected node. When more than a preset ratio (for example, 2/3) of the nodes in the blockchain network confirm a block, a transaction or data recorded in the block is deemed to be confirmed by the whole network. To meet the regulatory requirements of trading and transfer of some special products stipulated in national policies, consortium member users in the consortium blockchain may be users who have passed real-name authentication.

In some embodiments, the consortium blockchain uses a consensus algorithm such as the PoS, Practical Byzantine Fault Tolerance (PBFT), or a RAFT consensus algorithm. For example, before each round of consensus of the blockchain begins, a primary node, e.g., the consensus bookkeeping node in the foregoing embodiments, may be elected from the nodes of the blockchain (for example, a new primary node is elected in each round of consensus, and other nodes are secondary nodes). The primary node initiates verification and consensus of a transaction, and is responsible for creating a new block for the blockchain based on data of the transaction (or other target data) that is consented to.

As a consensus algorithm of the consortium blockchain provided in this specification, the PBFT algorithm has high consensus efficiency and can meet the requirement of a large volume of high-frequency transactions. For example, target purchase transactions are generated based on frequent purchase behaviors. Moreover, the consensus has a low time delay, satisfying the requirement of a real-time processing. Thus, the target purchase transactions can be quickly recorded in a newly generated block of the blockchain in real time. Further, by using a trusted node in the consortium blockchain network as a preselected bookkeeping node, both security and stability can be achieved. In addition, the use of the PBFT algorithm does not consume too many computing power resources of a computer, and does not necessarily require circulation of tokens, thus achieving good usability.

After a node of the blockchain invokes and executes the first smart contract based on the target purchase transaction, the purchase of the target product can be completed for the purchaser user, and a corresponding purchase proof is generated for the purchase. In some embodiments, the purchase of the target product is executed based on the invoking of the first smart contract, thus achieving high processing efficiency. The first smart contract can respond to an invoking request of a user at any time (without scheduling in advance and waiting for a working time for both parties of the contract, or waiting for both parties to sign the contract remotely, which are common in a conventional way of purchase), thereby greatly improving the efficiency of product purchase processing. Moreover, because logic (or terms) of the first smart contract are verified by the blockchain nodes based on a consensus and are tamper-resistant, an execution result of the logic is fair and visible, thereby avoiding disadvantages in the conventional way of purchase, such as a loss or damage of an interest of one party caused by an unfair product purchase and sale contract. Further, the product purchase behaviors do not need to be supervised or arbitrated by a centralized authority to ensure the fairness. Furthermore, because the purchase of the target product is performed based on the first smart contract, labor and time costs required for the target product purchase in the conventional way are greatly reduced, thereby achieving good economic efficiency.

In some embodiments, the target product may be a product that can produce fruits or earnings. For example, the target product is real estate. Then the purchaser user is entitled to the right to obtain an income based on leasing of the target product. When the target product is a product (such as a power station) capable of generating a secondary tradable product (for example, electricity generated by the power station) based on operation of the target product, the purchaser user is entitled to the right to obtain an income based on the secondary tradable product generated by the target product. To make it easy for the purchaser user to obtain a corresponding income based on the quantity of the purchased target product, the income generated based on the target product may be distributed by using a second smart contract deployed on the blockchain. In some embodiments, the purchaser user may select an operator to manage the income of the target product. For example, when the target product is large-scale special equipment, such as a power station, which is operated and maintained using professional knowledge, multiple purchaser users may select a professional operator for daily maintenance and financial management of the power station. The blockchain may include a node corresponding to the operator of the target product. The method for obtaining a corresponding income by the purchaser includes: receiving, by a node of the blockchain, a target income transaction sent by the node associated with the operator, where the target income transaction includes a total income obtained by operating the target product by the operator; and invoking the second smart contract based upon the target income transaction, to execute the income distribution logic declared in the second smart contract, and to distribute a corresponding income to the purchaser user based on the quantity of the target product distributed to the purchaser.

The foregoing step of distributing a corresponding income to the purchaser by invoking the second smart contract may be implemented in the following ways. An account transfer transaction is initiated to a blockchain account of the purchaser by using the second smart contract, to transfer the income of the purchaser in a form of tokens circulated on the blockchain or other smart assets. Alternatively, the second smart contract is executed to generate a corresponding income asset proof for the purchaser user, where the income asset proof includes a due income of the purchaser, and after the income asset proof is recorded into the distributed database of the blockchain, the purchaser user can require, by right of the income asset proof, the operator user to pay off-chain assets corresponding to the income. The foregoing step of distributing a corresponding income to the purchaser by invoking the second smart contract may be implemented in other ways.

The income generated by the target product purchased by the purchaser can be distributed based on the second smart contract, thus greatly improving the efficiency of income distribution processing. Moreover, because logic (or terms) of the second smart contract are verified by the blockchain nodes based on a consensus and are tamper-resistant, an execution result of the logic of the second smart contract is fair and visible, thereby avoiding unfair and unreasonable income distributions which may occur in the conventional purchase processes. The second smart contract may be a smart contract different from the first smart contract, or may be the first smart contract, that is, execution logic for income distribution of the target product is further declared in the first smart contract.

In some embodiments, due to a circulation attribute of a target product, the purchaser user may transfer all or a part of the target product owned. To ensure that the transfer process is performed smoothly, in some embodiments, the blockchain-based product purchase method may further include: receiving, by a node of the blockchain, a purchase transfer transaction sent by the purchaser node, where the purchase transfer transaction includes identification information of the transferee user (also referred to as a transferee) and a transfer quantity of the target product or a payment asset proof corresponding to the transfer quantity; and invoking the first smart contract based upon the purchase transfer transaction, to execute transfer logic declared in the first smart contract for transferring the target product, and to distribute the target product in the transfer quantity to the transferee user.

Similar to the foregoing embodiments, the identification information of the transferee user is identifier information for identifying an identity of the transferee user, for example, a public key of a blockchain account of the transferee, an address of the blockchain account of the transferee, or other anonymous information. In accordance with national regulatory requirements on special products, the identification information of the transferee may include real-name information of the transferee user, for example, an ID card, and business license information.

Similar to the foregoing embodiments, the foregoing step of invoking the first smart contract to distribute the target product in the transfer quantity to the transferee user may be implemented in many ways. For example, the target product may be distributed to the purchaser user in the transfer quantity or in coordination with other smart contracts (e.g., when the target product is smart assets in circulation on the blockchain). In another example, new purchase proofs may be generated for the purchaser user and the transferee user, so that the new purchase proofs are recorded in the distributed database of the blockchain after being verified by the nodes of the blockchain based on a consensus, where a new purchase proof for the purchaser user includes the identification information of the purchaser user and the quantity of the target product after the transfer, and the new purchase proof for the transferee user includes the identification information of the transferee user and the transfer quantity of the target product.

In some embodiments, similar to the foregoing purchase processes of the target product, the transfer process of the target product may be performed in response to the invoking of the first smart contract, thereby greatly improving the efficiency of transfer distribution process of the target product. Moreover, because the logic (or terms) of the first smart contract are verified by the blockchain nodes based on a consensus and are tamper-resistant, an execution result of the logic of the first smart contract is fair and visible, thereby avoiding unfair and unreasonable transfer processes which may occur if implemented in a conventional way.

Similar to the foregoing processes, embodiments of this specification further provide a blockchain-based product purchase apparatus 20. The apparatus 20 may be implemented through software, hardware, or a combination of software and hardware. Using a software implementation as an example, as a logical apparatus, the apparatus 20 is formed in the following manner: a central processing unit (CPU) of a device reads corresponding computer program instructions into an internal memory, and executes the computer program instructions. At a hardware level, in addition to a CPU, an internal memory, and a storage shown in FIG. 3, a device where an apparatus for product purchase is located further includes other hardware such as a chip for sending and receiving wireless signals, and/or other hardware such as a board for implementing network communications.

FIG. 2 shows a schematic diagram of an apparatus 20 for blockchain-based transactions according to some embodiments. A first smart contract for purchase management of a target product is deployed on a blockchain. As shown in FIG. 2, the apparatus 20 includes: a receiving unit 202, configured to receive a target purchase transaction, the target purchase transaction including identification information of a purchaser user of a target product and a payment asset proof of the purchaser user; and an execution unit 204, configured to invoke, based on the target purchase transaction, the first smart contract, to execute purchase logic in the first smart contract for a purchase of the target product, and to distribute, to the purchaser user, the target product in a quantity corresponding to the payment asset proof.

In some embodiments, invoking the first smart contract to distribute, to the purchaser user, the target product in a quantity corresponding to the payment asset proof includes: generating a purchase proof for the purchaser user, for the purchase proof to be recorded in a distributed database of the blockchain in response to the purchase proof being verified by a plurality of nodes of the blockchain based on a consensus, where the purchase proof comprises the identification information of the purchaser user and the quantity of the target product corresponding to the payment asset proof.

In some embodiments, the blockchain includes a node associated with the purchaser user (also referred to as a purchaser node) of the target product; and the target purchase transaction is an account transfer transaction sent by the purchaser node to the first smart contract.

In some embodiments, the blockchain further includes a node associated with an operator (also referred to as an operator node) of the target product; the receiving unit 202 is further configured to receive a target income transaction sent by the operator node, where the target income transaction includes a total income obtained by operating the target product by the operator; and the execution unit 204 is further configured to invoke a second smart contract based upon the target income transaction, to execute income distribution logic in the second smart contract, and to distribute an income to the purchaser user based on the quantity of the target product distributed to the purchaser user.

In some embodiments, the receiving unit 202 is further configured to receive a purchase transfer transaction sent by the purchaser node, where the purchase transfer transaction includes identification information of the transferee user, and a transfer quantity of the target product or a payment asset proof corresponding to the transfer quantity of the target product; and the execution unit 204 is further configured to invoke the first smart contract based upon the purchase transfer transaction, to execute transfer logic for the target product in the first smart contract for transferring the target product, and to distribute the target product in the transfer quantity to the transferee user.

In some embodiments, the blockchain is a consortium blockchain; and the purchaser user is a user who has passed a real-name authentication.

For implementation processes of the functions and effects of the units in the apparatus, refer to the implementation processes of the corresponding steps in the foregoing method. For similar parts, reference may be made to related descriptions in the method embodiments. Details are not elaborated herein again.

The apparatus embodiments described above is merely schematic. The units described as separate parts may or may not be physically separate, and the parts displayed as units may or may not be physical modules, may be located in one module, or may be distributed on multiple network modules. Some or all of the units or modules may be selected according to actual needs to achieve some or all objectives of the embodiments of this specification. Those of ordinary skill in the art should understand and implement this specification without creative efforts.

The apparatus, units and modules illustrated in the foregoing embodiments may be implemented by a computer chip or an entity, or implemented by a product having a function. A typical implementation device is a computing device, and examples of the computing device may include a personal computer, a laptop computer, a cellular phone, a camera phone, a smartphone, a personal digital assistant, a media player, a navigation device, an email sending and receiving device, a game console, a tablet computer, or a wearable device, or a combination of any of these devices.

Corresponding to the foregoing embodiments of the method, this specification further provides a computing device. The computing device includes a memory and a processor. The memory stores computer programs operable by the processor. When the processor operates the stored computer programs, the processor performs the steps of the blockchain-based product purchase method in the embodiments of this specification. For the detailed description of the steps of the blockchain-based product purchase method, refer to related content above, and the description is not repeated.

Corresponding to the foregoing embodiments of the method, this specification further provides a computer readable storage medium. The storage medium stores computer programs. When the computer programs are executed by a processor, steps of the blockchain-based product purchase method performed by a node of the blockchain in the embodiments of this specification are performed. For the detailed description of the steps of the blockchain-based product purchase method performed by the node of the blockchain, refer to related content above, and the description is not repeated.

The foregoing descriptions are merely some embodiments of this specification, but are not intended to limit this specification. Any modification, equivalent replacement, or improvement made within the spirit and principle of this specification shall fall within the protection scope of this specification.

In a typical configuration, the computing device includes one or more processors (CPUs), an input/output interface, a network interface, and a memory. The memory may include a volatile memory, a random access memory (RAM), and/or a non-volatile memory in a computer readable medium, such as a read-only memory (ROM) or a flash memory (flash RAM). The memory is an example of the computer readable medium.

The computer readable medium includes volatile and non-volatile, removable and non-removable media, which may store information by using any methods or technologies. The information may include computer readable instructions, data structures, program modules, or other data.

The examples of the computer storage medium include, but are not limited to, a phase change memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storages, a cassette, a tape, disk storage, or other magnetic storage devices, or any other non-transmission media, which may be configured to store information that may be accessible by a computing device. According to the descriptions in this specification, the computer readable medium does not include transitory computer readable media (transitory media), such as a modulated data signal and carrier.

It should be further noted that, the terms “include,” “comprise,” and any variants thereof are intended to cover a non-exclusive inclusion. Therefore, in the context of a process, a method, a product, or a device that includes a series of elements, the process, method, product or device not only includes such elements, but also includes other elements not specified expressly, or may include elements inherent to the process, method, product or device. Without more restrictions, an element limited by “include a/an . . . ” does not exclude other same elements existing in the process, method, product or device that includes the element.

Those skilled in the art should understand that the embodiments of this specification may be provided as a method, a system, or a computer program product. Therefore, the embodiments of this specification may use a form of hardware-only embodiments, software-only embodiments, or embodiments combining software and hardware. Moreover, the embodiments of this specification may use a form of a computer program product that is implemented on one or more computer-usable storage media (including, but not limited to, a disk memory, a CD-ROM, an optical memory, and the like) that include computer-readable program codes.

What is claimed is:

1. A computer-implemented method for blockchain-based transactions, comprising:
receiving a target purchase transaction which comprises identification information of a purchaser user of a target product and a payment asset proof of the purchaser user; and
invoking, based on the target purchase transaction, a first smart contract deployed on a blockchain to execute a purchase of the target product, and to distribute, to the purchaser user, the target product in a quantity corresponding to the payment asset proof.

2. The method according to claim 1, wherein invoking, based on the target purchase transaction, a first smart contract deployed on a blockchain to execute a purchase of the target product, and to distribute, to the purchaser user, the target product in a quantity corresponding to the payment asset proof comprises:
generating a purchase proof for the purchaser user, for the purchase proof to be recorded in a distributed database of the blockchain in response to the purchase proof being verified by a plurality of nodes of the blockchain based on a consensus, wherein the purchase proof comprises the identification information of the purchaser user and the quantity of the target product corresponding to the payment asset proof.

3. The method according to claim 2, wherein the quantity of the target product is a proportion of an ownership of the target product.

4. The method according to claim 1, wherein the target purchase transaction is an account transfer transaction sent by a node associated with the purchaser user for transferring a smart asset in the blockchain.

5. The method according to claim 1, wherein the identification information of the purchaser user includes a public key of the purchaser user or an address of a blockchain account of the purchaser user in the blockchain.

6. The method according to claim 1, wherein the payment asset proof includes a payment proof of token, digital asset, cash, security, coupon, or real estate, or a bank account transfer proof.

7. The method according to claim 1, wherein the target purchase transaction is sent by a node associated with a seller user of the target product; and the target purchase transaction includes payment receipt information.

8. The method according to claim 1, further comprising:
receiving a target income transaction sent by a node associated with an operator of the target product, wherein the target income transaction comprises a total income obtained by operating the target product by the operator; and
invoking, based on the target income transaction, a second smart contract to distribute an income to the purchaser user based on the quantity of the target product distributed to the purchaser user.

9. The method according to claim 1, further comprising:
receiving a purchase transfer transaction sent by a node associated with the purchaser user, wherein the purchase transfer transaction comprises identification information of a transferee user, and a transfer quantity of the target product or a payment asset proof corresponding to the transfer quantity of the target product; and
invoking, based on the purchase transfer transaction, the first smart contract to distribute the transfer quantity of the target product to the transferee user.

10. The method according to claim 1, wherein the blockchain is a consortium blockchain.

11. The method according to claim 1, wherein the purchaser user is a user who has passed a real-name authentication.

12. The method according to claim 1, wherein the consensus is based on a Proof of Work (PoW) mechanism, a Delegated Proof of Stake (DPoS) mechanism, a Proof of Stake (PoS) mechanism, a Practical Byzantine Fault Tolerance (PBFT) consensus algorithm, or a RAFT consensus algorithm.

13. An apparatus for blockchain-based transactions, comprising one or more processors and one or more non-transitory computer-readable memories coupled to the one or more processors and configured with instructions executable by the one or more processors to cause the apparatus to perform operations comprising:
receiving a target purchase transaction which comprises identification information of a purchaser user of a target product and a payment asset proof of the purchaser user; and
invoking, based on the target purchase transaction, a first smart contract deployed on a blockchain to execute a purchase of the target product, and to distribute, to the purchaser user, the target product in a quantity corresponding to the payment asset proof.

14. The apparatus according to claim 13, wherein invoking a first smart contract deployed on a blockchain to execute a purchase of the target product, and to distribute, to the purchaser user, the target product in a quantity corresponding to the payment asset proof comprises:
generating a purchase proof for the purchaser user, for the purchase proof to be recorded in a distributed database of the blockchain in response to the purchase proof being verified by a plurality of nodes of the blockchain based on a consensus, wherein the purchase proof comprises the identification information of the purchaser user and the quantity of the target product corresponding to the payment asset proof.

15. The apparatus according to claim 13, wherein the identification information of the purchaser user includes a public key of the purchaser user or an address of a blockchain account of the purchaser user in the blockchain.

16. The apparatus according to claim 13, wherein the payment asset proof includes a payment proof of token, digital asset, cash, security, coupon, or real estate, or a bank account transfer proof.

17. The apparatus according to claim 13, wherein the operations further comprise:
receiving a target income transaction sent by a node associated with an operator of the target product, wherein the target income transaction comprises a total income obtained by operating the target product by the operator; and
invoking, based on the target income transaction, a second smart contract to distribute an income to the purchaser user based on the quantity of the target product distributed to the purchaser user.

18. The apparatus according to claim 13, wherein the operations further comprise:
receiving a purchase transfer transaction sent by a node associated with the purchaser user, wherein the purchase transfer transaction comprises identification information of a transferee user, and a transfer quantity of the target product or a payment asset proof corresponding to the transfer quantity of the target product; and
invoking, based on the purchase transfer transaction, the first smart contract to distribute the transfer quantity of the target product to the transferee user.

19. The apparatus according to claim 13, wherein the blockchain is a consortium blockchain.

20. A non-transitory computer-readable storage medium configured with instructions executable by one or more processors to cause the one or more processors to perform operations comprising:
receiving a target purchase transaction which comprises identification information of a purchaser user of a target product and a payment asset proof of the purchaser user; and
invoking, based on the target purchase transaction, a first smart contract deployed on a blockchain to execute a purchase of the target product, and to distribute, to the purchaser user, the target product in a quantity corresponding to the payment asset proof.
